(19) United States
(12) Patent Application Publication
(10) Pub. No.: US 2011/0223532 A1
(43) Pub. Date: Sep. 15, 2011

(54) TONER AND DEVELOPER

(76) Inventors: Tsuyoshi SUGIMOTO, Shizuoka (JP); Fumihiro Sasaki, Shizuoka (JP); Hiroshi Yamashita, Shizuoka (JP); Satoshi Ogawa, Nara (JP); Junichi Awamura, Shizuoka (JP); Hyo Shu, Kanagawa (JP); Tomomi Suzuki, Shizuoka (JP); Teruki Kusahara, Shizuoka (JP); Ryota Inoue, Osaka (JP); Daisuke Inoue, Shizuoka (JP)

(21) Appl. No.: 13/025,277

(22) Filed: Feb. 11, 2011

(30) Foreign Application Priority Data
Mar. 10, 2010 (JP) 2010-052966

(51) Int. Cl. G03G 9/087

(52) U.S. Cl. 430/109.4

(57) ABSTRACT

A toner, comprising a colorant, a crystalline polyester resin, and an amorphous polyester resin, in which the crystalline polyester resin satisfies the following relations:

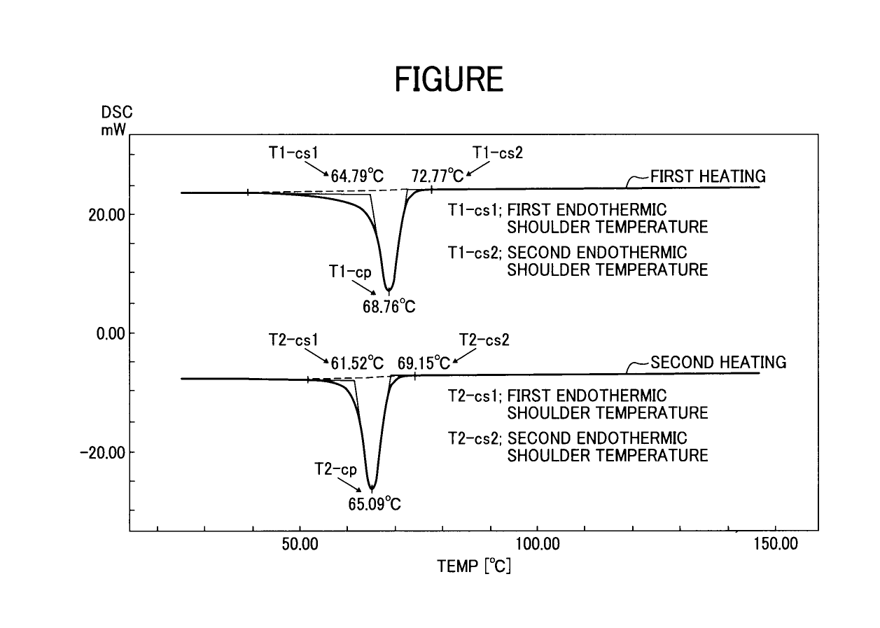

60≦(T2-cp)<80

(T2-cs2)−(T2-cp)<10

(T2-cp)−(T2-cs1)<10

wherein (T2-cp) (° C.) represents an endothermic peak temperature, (T2-cs1) (° C.) represents a first endothermic shoulder temperature, and (T2-cs2) (° C.) represents a second endothermic shoulder temperature, each determined from a second heating in a differential scanning calorimetry.

### CROSS-REFERENCE TO RELATED APPLICATIONS

The present patent application claims priority pursuant to 35 U.S.C. §119 from Japanese Patent Application No. 2010-052966, filed on Mar. 10, 2010, which is hereby incorporated by reference herein in its entirety.

### BACKGROUND

1. Field of the Invention

The present invention relates to a toner for use in electrophotography, electrostatic recording, and electrostatic printing. In addition, the present invention also relates to a developer using the toner.

2. Description of the Background

In electrophotography, electrostatic recording, and electrostatic printing, an electrostatic latent image is formed on an image bearing member (e.g., a photoreceptor). A developer develops the electrostatic latent image into a toner image that is visible. The toner image is then transferred onto a recording medium (e.g., paper) and fixed thereon.

Developers are classified into one-component developers comprised of a toner and two-component developers comprised of a toner and a carrier.

In most electrophotographic image forming processes, from the viewpoint of energy efficiency, a toner image is fixed on a recording medium by directly pressing a heating roller against the toner image on the recording medium. This fixing method may be hereinafter referred to as a heating roller method.

The heating roller method disadvantageously consumes a large amount of electricity. Therefore, there have been various attempts to reduce electricity consumption in the heating roller method. For example, one attempt includes reducing power output of a heater for heating the heating roller while forming no image (i.e., during sleep mode) and increasing it while forming images, which has been widely employed. However, in this case, users have to wait several ten seconds until the heating roller recovers from the sleep mode to be ready for fixing.

There is another attempt in which the heater is completely turned off during sleep mode. In this attempt, toners are required to be fixable at much lower temperatures.

To meet this requirement for low-temperature fixability and storage stability (blocking resistance), polyester resins are employed as toner binder in place of styrene resins recently. Polyester resins have better affinity for recording media compared to styrene resins.

For example, Japanese Patent Application Publication No. (hereinafter JP-A) 2004-245854 discloses a toner including a linear polyester resin having specific properties, and JP-H04-70765-A discloses a toner including a non-linear cross-linked polyester resin obtained from a rosin.

However, these toners do not meet recent demand for high-speed and energy-saving image forming apparatus in which both the fixing period is shortened and the fixing temperature is reduced, and may result in weak fixation on a recoding medium.

The toner disclosed in JP-H04-70765-A has an advantage in productivity when the toner is manufactured through a pulverization process because the polyester resin obtained from a rosin, as an acid component, is easy to pulverize. Additionally, the polyester resin obtained from a combination of the rosin and 1,2-propanediol that is a branched alcohol having 3 carbon atoms, as an alcohol component, is fixable at much lower temperatures than that obtained from an alcohol having at most 2 carbon atoms, while maintaining offset resistance. Also, such a polyester resin has better storage stability than that obtained from a branched alcohol having at least 4 carbon atoms even when the glass transition temperature is low.

Even if these polyester resins now meet the requirement for low-temperature fixability, it will be difficult for them to respond stricter requirements for energy saving in the near future.

In attempting to more improve both low-temperature fixability and heat-resistant storage stability, JP-2006-208609-A discloses a toner including a resin and a fixing auxiliary component being a plasticizer compatible with the resin upon heating. The fixing auxiliary agent exists as crystalline domains in the toner. JP-2009-109971-A and JP-2006-337872-A each disclose a toner including a crystalline polyester resin. However, each of these toners is still unsatisfactory to be used in high-speed and energy-saving image forming apparatus.

### SUMMARY

Exemplary aspects of the present invention are put forward in view of the above-described circumstances, and provide novel toner and developer having a good combination of low-temperature fixability and hot offset resistance. The novel toner and developer produce high-definition and high-quality images for an extended period of time without contaminating a fixing device in use or the resulting images.

In one exemplary embodiment, a novel toner comprises a colorant, a crystalline polyester resin, and an amorphous polyester resin, and the crystalline polyester resin satisfies the following relations:

60≦(T2-cp)<80

(T2-cs2)−(T2-cp)<10

(T2-cp)−(T2-cs1)<10

wherein (T2-cp) (° C.) represents an endothermic peak temperature, (T2-cs1) (° C.) represents a first endothermic shoulder temperature, and (T2-cs2) (° C.) represents a second endothermic shoulder temperature, each determined from a second heating in a differential scanning calorimetry.

In another exemplary embodiment, the above toner is manufactured by dispersing an oil phase comprising an organic solvent, the colorant, the crystalline polyester resin, and the amorphous polyester resin, in an aqueous medium to prepare an O/W dispersion; and removing the organic solvent from the O/W dispersion.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGURE shows an exemplary differential scanning calorimetric chart of the crystalline polyester resin according to this specification.

### DETAILED DESCRIPTION

Exemplary aspects of the invention provide a toner comprising a colorant, a crystalline polyester resin, and an amorphous polyester resin, in which the crystalline polyester resin satisfies the following relations:

60≦(T2-cp)<80

(T2-cs2)−10<(T2-cp)<(T2-cs1)+10

wherein (T2-cp) (° C.) represents an endothermic peak temperature, (T2-cs1) (° C.) represents a first endothermic shoulder temperature, and (T2-cs2) (° C.) represents a second endothermic shoulder temperature, each determined from a second heating in a differential scanning calorimetry.

The toner may be manufactured by dispersing an oil phase comprising an organic solvent, the colorant, the crystalline polyester resin, and the amorphous polyester resin, in an aqueous medium to prepare an O/W dispersion, and removing the organic solvent from the O/W dispersion.

The crystalline polyester resin rapidly reduces its viscosity and melts at around the endothermic peak temperature owing to its crystallinity. Accordingly, the crystalline polyester resin keeps heat-resistant storage stability until just before rapidly reducing its viscosity and melting to be fixed on a recording medium. Thus, the toner including such a crystalline polyester resin has both heat-resistant storage stability and low-temperature fixability.

To more improve heat-resistant storage stability and low-temperature fixability, the crystalline polyester resin preferably has a sharp endothermic curve in which an endothermic peak exists within a temperature range of from 60 to 80° C. More preferably, the endothermic peak exists within a temperature range of from 65 to 75° C.

Preferably, the difference between the first endothermic shoulder temperature (T2-cs1) (° C.) and the second endothermic shoulder temperature (T2-cs2) (° C.) is as small as possible. The smaller the difference, the smaller variation in molecular composition and weight distribution of the crystalline polyester resin. Such a crystalline polyester resin rapidly reduces its viscosity at around the endothermic peak temperature, thus improving low-temperature fixability of the toner.

To more improve heat-resistance storage stability and blocking resistance, the difference between the endothermic peak temperature (T2-cp) (° C.) and the first endothermic shoulder temperature (T2-cs1) (° C.) is preferably less than 10, more preferably less than 6. The smaller the difference, the smaller the amount of low-thermal-property components present in the crystalline polyester resin.

To more improve low-temperature fixability, the difference between the endothermic peak temperature (T2-cp) (° C.) and the second endothermic shoulder temperature (T2-cs2) (° C.) is preferably less than 10, more preferably less than 6. The smaller the difference, the smaller the amount of high-thermal-property components present in the crystalline polyester resin.

The endothermic peak temperature (T2-cp) (° C.) can be controlled by changing monomer composition or weight average molecular weight of the crystalline polyester resin.

The difference between the endothermic peak temperature (T2-cp) (° C.) and the first or second endothermic shoulder temperature (T2-cs1) or (T2-cs2) (° C.) can be made much smaller by increasing crystallinity of the crystalline polyester resin. This can be achieved by obtaining the crystalline polyester resin from acid and alcohol monomers which are similar in composition. In this case, portions having an identical structure in molecular chains overlap with each other at a high probability, resulting in high crystallinity.

Additionally, the difference between the endothermic peak temperature (T2-cp) (° C.) and the first or second endothermic shoulder temperature (T2-cs1) or (T2-cs2) (° C.) can be made much smaller by reducing the difference between the number and weight average molecular weights of the crystalline polyester resin.

Suitable organic solvents for manufacturing the toner include those which completely dissolve the crystalline polyester resin to form a uniform liquid at high temperatures, while separate from the crystalline polyester resin to form an opaque nonuniform liquid at low temperatures.

More specifically, organic solvents which behave as non-solvent below (Tm-40) (° C.) and good solvent at and above (Tm-40) (° C.) are preferable. Here, Tm (° C.) represents the melting temperature of the crystalline polyester resin. Specific examples of such solvents include, but are not limited to, toluene, ethyl acetate, butyl acetate, methyl ethyl ketone, and methyl isobutyl ketone. Two or more of these solvents can be used in combination.

The crystalline polyester resin can be obtained from an alcohol component and an acid component. Specific preferred examples of suitable alcohol components include, but are not limited to, saturated aliphatic diol compounds having 2 to 12 carbon atoms, such as 1,4-butanediol, 1,6-hexanediol, 1,8-octanediol, 1,10-decanediol, 1,12-dodecanediol, and derivatives thereof. Specific preferred examples of suitable acid components include, but are not limited to, dicarboxylic acids having a C═C double bond and 2 to 12 carbon atoms, and saturated dicarboxylic acids having 2 to 12 carbon atoms, such as fumaric acid, 1,4-butanedioic acid, 1,6-hexanedioic acid, 1,8-octanedioic acid, 1,10-decanedioic acid, 1,12-dodecanedioic acid, and derivatives thereof.

To make the difference between the endothermic peak temperature (T2-cp) (° C.) and the first or second endothermic shoulder temperature (T2-cs1) or (T2-cs2) (° C.) much smaller, the alcohol component preferably comprises at least one of 1,4-butanediol, 1,6-hexanediol, 1,8-octanediol, 1,10-decanediol, and 1,12-dodecanediol, and the acid component preferably comprises at least one of fumaric acid, 1,4-butanedioic acid, 1,6-hexanedioic acid, 1,8-octanedioic acid, 1,10-decanedioic acid, and 1,12-dodecanedioic acid.

The crystalline polyester resin preferably has an acid value of 5 mgKOH/g or more, more preferably 10 mgKOH/g or more, to improve affinity for paper to improve low-temperature fixability. On the other hand, the crystalline polyester resin preferably has an acid value of 45 mgKOH/g or less to improve hot offset resistance.

The crystalline polyester resin preferably has a hydroxyl value of from 0 to 50 mgKOH/g, more preferably from 5 to 50 mgKOH/g, to improve low-temperature fixability and chargeability.

Molecular structure of the crystalline polyester resin can be determined by liquid NMR, solid NMR, X-ray diffraction, GC/MS, LC/MS, IR, or the like. One exemplary method for determining molecular structure include observing an infrared absorption spectrum to determine whether the spectrum has an absorption peak based on δCH (out-of-plane bending vibration) of olefin at 965±10 cm⁻¹ or 990±10 cm⁻¹.

It is known that a resin having a narrow molecular weight distribution and a low average molecular weight has low-temperature fixability, and that including a large amount of low-molecular-weight components has poor heat-resistant storage stability. In view of this, a molecular weight (M) distribution chart obtained by gel permeation chromatography, having the lateral axis indicating “log(M)” and the vertical axis indicating “% by weight”, of o-dichlorobenzene-soluble components in the crystalline polyester resin preferably has a peak having a half bandwidth of 1.5 or less within a lateral range log(M) of from 3.5 to 4.0. Additionally, it is preferable that the weight average molecular weight (Mw) is from 3,000 to 30,000, the number average molecular weight (Mn) is from 1,000 to 10,000, and the ratio Mw/Mn is from 1 to 10. It is more preferable that the weight average molecular weight (Mw) is from 5,000 to 15,000, the number average molecular weight (Mn) is from 2,000 to 10,000, and the ratio Mw/Mn is from 1 to 5.

Also, properties of the crystalline polyester resin, such as crystallinity, softening point, and hot offset resistance, is easy to control when the crystalline polyester resin is a non-linear polyester prepared using a polyol having 3 or more valences (e.g., glycerin) as the alcohol component and a polycarboxylic acid having 3 or more valences (e.g., trimellitic anhydride) as the acid component.

The amorphous polyester resin may comprise an unmodified polyester resin and a modified polyester resin. The modified polyester resin is preferably obtained by elongating and/or cross-linking a precursor thereof.

The unmodified polyester resin is preferably at least partially compatible with the modified polyester resin, so as to improve low-temperature fixability and hot offset resistance of the resulting toner.

Therefore, the modified and unmodified polyester resins are preferably composed of similar polyols and polycarboxylic acids.

The unmodified polyester resin preferably satisfies the following relation:

45≦(T2-ns1)<65

and more preferably, the following relation:

45≦(T2-ns1)<55

wherein (T2-ns1) (° C.) represents an endothermic shoulder temperature determined from the second heating in the differential scanning calorimetry.

When (T2-ns1) (° C.) is too small, heat-resistant storage stability of the resulting toner may be poor. When (T2-ns1) (° C.) is too large, low-temperature fixability of the resulting toner may be poor.

The unmodified polyester resin preferably has an acid value of from 1 to 50 KOHmg/g, and more preferably from 5 to 30 KOHmg/g, so that the resulting toner is negatively chargeable and has better affinity for paper to more improve low-temperature fixability. When the acid value is too large, environmental charge stability may be poor.

The unmodified polyester resin preferably has a hydroxyl value of 5 KOHmg/g or more.

As described above, the modified polyester resin is preferably obtained by elongating and/or cross-linking a precursor thereof.

Accordingly, the toner may be manufactured by dispersing an oil phase in an aqueous medium containing a particle dispersant to prepare an O/W dispersion, the oil phase comprising an organic solvent, the colorant, the crystalline polyester resin, the unmodified polyester resin, a precursor of the modified polyester resin, and a compound capable of elongating and/or cross-linking with the precursor; elongating and/or cross-linking the compound with the precursor in the O/W dispersion; and removing the organic solvent from the O/W dispersion.

As the precursor of the modified polyester resin, for example, a polyester prepolymer modified with an isocyanate, an epoxy, or the like is preferable. Such a polyester prepolymer elongates with a compound having an active hydrogen group (e.g., an amine), and the resulting modified polyester resin contributes to a wider fixable temperature range of the toner.

The polyester prepolymer can be obtained by reacting a base polyester with an isocyanating agent or an epoxidation agent.

Specific examples of usable isocyanating agents include, but are not limited to, aliphatic polyisocyanates (e.g., tetramethylene diisocyanate, hexamethylene diisocyanate, 2,6-diisocyanatomethyl caproate); alicyclic polyisocyanates (e.g., isophorone diisocyanate, cyclohexylmethane diisocyanate); aromatic diisocyanate (e.g., tolylene diisocyanate, diphenylmethane diisocyanate); aromatic aliphatic diisocyanates (e.g., α,α,α′,α′-tetramethylxylylene diisocyanate); isocyanurates; and the above polyisocyanates blocked with a phenol derivative, an oxime, or a caprolactam. Two or more of these compounds can be used in combination.

Specific examples of usable epoxidation agents include, but are not limited to, epichlorohydrin.

The equivalent ratio [NCO]/[OH] of isocyanate groups [NCO] in the isocyanating agent to hydroxyl groups [OH] in the base polyester is preferably from 5/1 to 1/1, more preferably from 4/1 to 1.2/1, and most preferably from 2.5/1 to 1.5/1. When [NCO]/[OH] is too large, low-temperature fixability of the resulting toner may be poor. When [NCO]/[OH] is too small, hot offset resistance of the resulting toner may be poor because the amount of urea bonds in the resultant polyester prepolymer is too small.

The content of the isocyanating agent in the resulting polyester prepolymer is preferably from 0.5 to 40% by weight, more preferably from 1 to 30% by weight, and most preferably from 2 to 20% by weight. When the content is too small, hot offset resistance, heat-resistant storage stability, and low-temperature fixability of the resulting toner may be poor. When the content is too large, low-temperature fixability of the resulting toner may be poor.

The number of isocyanate groups in one molecule of the resulting polyester prepolymer is preferably 1 or more. The average number is preferably from 1.5 to 3, more preferably from 1.8 to 2.5. When the number of isocyanate groups per molecule is too small, hot offset resistance of the resulting toner may be poor because the molecular weight of the resulting urea-modified polyester is too small.

The precursor of the modified polyester resin preferably has a weight average molecular weight of from 1×10⁴ to 3×10⁵.

The polyester prepolymer elongates and/or cross-links with a compound having an active hydrogen group such as an amine.

Specific examples of usable amines include, but are not limited to, diamine compounds, polyamine compounds having 3 or more valences, amino alcohol compounds, amino mercaptan compounds, amino acid compounds, and such compounds in which the amino group is blocked.

Specific examples of the diamine compounds include, but are not limited to, aromatic diamines (e.g., phenylenediamine, diethyltoluenediamine, 4,4′-diaminophenylmethane); alicyclic diamines (e.g., 4,4′-diamino-3,3′-dimethyldicyclohexylmethane, diamine cyclohexane, isophoronediamine); and aliphatic diamines (e.g., ethylenediamine, tetramethylenediamine, hexamethylenediamine).

Specific examples of the polyamine compounds having 3 or more valences include, but are not limited to, diethylenetriamine and triethylenetetramine.

Specific examples of the amino alcohol compounds include, but are not limited to, ethanolamine and hydroxyethylaniline.

Specific examples of the amino mercaptan compounds include, but are not limited to, aminoethyl mercaptan and aminopropyl mercaptan.

Specific examples of the amino acid compounds include, but are not limited to, aminopropionic acid and aminocaproic acid.

Specific examples of the above compounds in which the amino group is blocked include, but are not limited to, ketimine compounds prepared from amines and ketones (e.g., acetone, methyl ethyl ketone, methyl isobutyl ketone), and oxazoline compounds.

Among the above-described amines, diamine compounds and mixtures of a diamine compound and a small amount of a polyamine compound are preferable.

The toner may further include binder resins other than the above-described modified or unmodified polyester resins, for example, a urethane-modified polyester resin.

Additionally, the toner may include a urea-modified polyester resin obtained by a method called one-shot method as follows.

First, a polyol and a polycarboxylic acid are heated to 150 to 280° C. in the presence of a catalyst (e.g., tetrabutoxy titanate, dibutyltin oxide), while depressurizing and removing the produced water, if needed, to prepare a polyester resin having a hydroxyl group.

Next, the polyester resin having a hydroxyl group is reacted with a polyisocyanate at 40 to 140° C., to prepare a polyester prepolymer having an isocyanate group.

Last, the polyester prepolymer having an isocyanate group is reacted with an amine at 0 to 140° C. Thus, a urea-modified polyester resin is obtained.

The urea-modified polyester resin thus prepared preferably has a number average molecular weight of from 1,000 to 10,000, and more preferably from 1,500 to 6,000.

When the polyester resin having a hydroxyl group reacts with a polyisocyanate, and/or the polyester prepolymer having an isocyanate group reacts with an amine, a solvent can be used, if needed.

Specific examples of usable solvents include, but are not limited to, aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran), which are inactive with the isocyanate group.

As described above, the toner may further include binder resins other than the crystalline polyester resin and the amorphous polyester resin including the modified and unmodified polyester resins.

Preferably, the binder resins are comprised of 50% by weight or more of polyester resins. When the amount of polyester resins is too small, low-temperature fixability of the toner may be poor. More preferably, the binder resins are comprised of only polyester resins.

Specific examples of usable binder resins other than polyester resins include, but are not limited to, polymers of styrene or styrene derivatives (e.g., polystyrene, poly-p-chlorostyrene, polyvinyl toluene), styrene-based copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer), polymethyl methacrylate, polybutyl methacrylate, polyvinyl chloride, polyvinyl acetate, polyethylene, polypropylene, epoxy resin, epoxy polyol resin, polyurethane resin, polyamide resin, polyvinyl butyral, polyacrylic acid, rosin, modified rosin, terpene resin, aliphatic or alicyclic hydrocarbon resin, aromatic petroleum resin, chlorinated paraffin, and paraffin wax.

The ratio of the crystalline polyester resin to the amorphous polyester resin is preferably from 3/97 to 45/55, and more preferably from 5/95 to 20/80. When the ratio of the crystalline polyester resin is too small, low-temperature fixability of the toner may be poor. When the ratio of the crystalline polyester resin is too large, hot offset resistance and heat-resistant storage stability of the toner may be poor.

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. Two or more of such colorants can be used in combination. The content of the colorant in the toner is preferably from 1 to 15% by weight, and more preferably from 3 to 10% by weight.

The colorant can be combined with a resin to be used as a master batch. Specific examples of usable resin for the master batch include, but are not limited to, polyesters, polymers of styrene or styrene derivatives (e.g., polystyrene, poly-p-chlorostyrene, polyvinyl toluene), styrene-based copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer), polymethyl methacrylate, polybutyl methacrylate, polyvinyl chloride, polyvinyl acetate, polyethylene, polypropylene, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. Two or more of such resins can be used in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

The toner may further include a release agent. Suitable release agents include waxes having a melting point of from 50 to 120° C. Such a wax effectively functions as a release agent at between a fixing roller and a toner particle to prevent the occurrence of high-temperature offset without applying oil to the fixing roller.

Melting point of wax can be determined by measuring a maximum endothermic peak using a differential scanning calorimeter such as TG-DSC system TAS-100 from (Rigaku Corporation).

Specific preferred materials for the release agent include, but are not limited to, natural waxes such as plant waxes (e.g., carnauba wax, cotton wax, sumac wax, rice wax), animal waxes (e.g., bees wax, lanoline), mineral waxes (e.g., ozokerite, ceresin), and petroleum waxes (e.g., paraffin, microcrystalline, petrolatum); synthetic hydrocarbon waxes (e.g., Fischer-Tropsch wax, polyethylene wax); and synthetic waxes (e.g., ester, ketone, ether).

Additionally, the following crystalline polymers are also suitable for the release agent: fatty acid amides (e.g., 1,2-hydroxystearic acid amide, stearic acid amide, phthalic anhydride imide, chlorinated hydrocarbon); and low-molecular-weight crystalline polymers such as homopolymers or copolymers of polyacrylates (e.g., n-stearyl polymethacrylate, n-lauryl polymethacrylate, n-stearyl acrylate-ethyl methacrylate copolymer) having a long-chain alkyl side group.

The toner may further include a chare controlling agent. Specific examples of usable charge controlling agent include, but are not limited to, Nigrosine dyes, triphenylmethane dyes, metal complex dyes including chromium, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives.

Specific examples of commercially available charge controlling agents include, but are not limited to, BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, and a quaternary ammonium group.

The content of the charge controlling agent is preferably 0.1 to 10 parts by weight, more preferably from 0.2 to 5 parts by weight, based on 100 parts by weight of the binder resin. When the content of charge controlling agent is too large, the toner may be excessively charged and electrostatically attracted to a developing roller, resulting in poor fluidity of the toner and low image density.

The charge controlling agent may be directly mixed with the binder resin or the master batch, or added to the toner components liquid. Alternatively, the charge controlling agent may be fixed on the surface of the toner.

The toner may further include an external additive on the surface thereof to improve fluidity, developability, and chargeability.

Specific preferred materials suitable for the external additive include particulate inorganic materials. The particulate inorganic materials preferably have a primary diameter of from 5 nm to 2 μm, and more preferably from 5 nm to 500 mμ. The particulate inorganic materials preferably have a BET specific surface area of from 20 to 500 m²/g.

The content of the particulate inorganic material is preferably from 0.01 to 5% by weight, more preferably from 0.01 to 2.0% by weight, based on the toner.

Specific examples of usable particulate inorganic materials include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

Additionally, particles of polymers prepared by soap-free emulsion polymerization, suspension polymerization, or dispersion polymerization (e.g., polystyrene, copolymers of methacrylates or acrylates), polycondensation polymers (e.g., silicone, benzoguanamine, nylon), and thermosetting resins are also usable as the external additive.

The external additive may be surface-treated with a hydrophobizing agent so that fluidity and chargeability of the toner may not deteriorate even under high-humidity conditions. Specific examples of usable hydrophobizing agents include, but are not limited to, silane coupling agents, silylation agents, silane coupling agents having a fluorinated alkyl group, organic titanate coupling agents, aluminum coupling agents, silicone oils, and modified silicone oils.

The toner may further include a cleanability improving agent so as to be easily removable from a photoreceptor or a primary transfer medium when remaining thereon after image transfer. Specific preferred materials suitable for the cleanability improving agent include, but are not limited to, metal salts of fatty acids (e.g., zinc stearate, calcium stearate), and fine particles of polymers prepared by soap-free emulsion polymerization (e.g., polymethyl methacrylate, polystyrene). Such fine particles of polymers preferably have a narrow size distribution and a volume average particle diameter of from 0.01 to 1 μm.

As described above, the toner may be manufactured by dispersing an oil phase comprising an organic solvent, the colorant, the crystalline polyester resin, and the amorphous polyester resin, in an aqueous medium to prepare an O/W dispersion, and removing the organic solvent from the O/W dispersion.

Alternatively, the toner may be manufactured by dispersing an oil phase in an aqueous medium containing a particle dispersant to prepare an O/W dispersion, the oil phase comprising an organic solvent, the colorant, the crystalline polyester resin, the unmodified polyester resin, a precursor of the modified polyester resin, and a compound capable of elongating and/or cross-linking with the precursor; elongating and/or cross-linking the compound with the precursor in the O/W dispersion; and removing the organic solvent from the O/W dispersion.

The oil phase may be hereinafter referred to as the “toner components liquid”. The O/W dispersion may be hereinafter referred to as the “emulsion”.

The aqueous medium may be, for example, water alone or a mixture of water with a water-miscible solvent.

Specific examples of usable water-miscible solvents include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone).

The toner components, such as a colorant, a release agent, a charge controlling agent, the crystalline polyester resin, the amorphous polyester resin, the unmodified polyester resin, and a precursor of the modified polyester resin, may be mixed at the time they are added to the aqueous medium. However, it is more preferable that the toner components are previously mixed with each other, and the resultant mixture is added to the aqueous medium.

The colorant, release agent, and charge controlling agent are not necessarily mixed with other toner components at the time they are added to the aqueous medium, and may be added to the resulting particles. Alternatively, the resulting particles can be dyed with a colorant.

The toner component liquid is dispersed in the aqueous medium using a low-speed shearing disperser, a high-speed shearing disperser, a frictional disperser, a high-pressure jet disperser, or an ultrasonic disperser, for example. A high-speed shearing disperser is preferable for controlling the particle diameter of the dispersing oil droplets into 2 to 20 μm.

As for the high-speed shearing disperser, the revolution is preferably from 1,000 to 30,000 rpm, and more preferably from 5,000 to 20,000 rpm. The dispersing time is preferably from 0.1 to 60 minutes. The dispersing temperature is preferably from 0 to 80° C. (under pressure), and more preferably from 10 to 40° C.

The amount of the aqueous medium is preferably from 100 to 1,000 parts by weight based on 100 parts by weight of the toner components. When the amount of the aqueous medium is too small, the toner components may not be finely dispersed therein, and therefore the resulting toner may not have a desired particle size. When the amount of the aqueous medium is too large, manufacturing cost may increase.

The aqueous medium may contain a dispersant. The dispersant narrows the size distribution of the resulting toner and stabilizes the dispersion.

To make the polyester prepolymer react with the compound having an active hydrogen group, the compound having an active hydrogen group may be mixed with the toner components including the polyester prepolymer before they are added to the aqueous medium. Alternatively, the compound having an active hydrogen group may be added to the aqueous medium after the toner components including the polyester prepolymer are dispersed therein. In the latter case, the resulting urea-modified polyester resin is dominantly formed at the surface of the toner particle, generating a concentration gradient of urea bonds within the toner particle.

The aqueous medium may contain a dispersant to reliably emulsify or disperse the toner components liquid (i.e., the oil phase) in the aqueous medium. Specific examples of usable dispersants include, but are not limited to, anionic surfactants (e.g., alkylbenzene sulfonate, α-olefin sulfonate, phosphate), amine salt type cationic surfactants (e.g., alkylamine salts, amino alcohol fatty acid derivatives, imidazoline), quaternary ammonium salt type cationic surfactants (e.g., alkyl trimethyl ammonium salt, dialkyl dimethyl ammonium salt, alkyl dimethyl benzyl ammonium salt, pyridinium salt, alkyl isoquinolinium salt, benzethonium chloride), nonionic surfactants (e.g., fatty acid amide derivatives, polyol derivatives), and ampholytic surfactants (e.g., alanine, dodecyl di(aminoethyl) glycine, di(octyl aminoethyl) glycine, N-alkyl-N,N-dimethyl ammonium betaine).

Surfactants having a fluoroalkyl group are also usable. Specific examples of anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid dimethanol amide, N-propyl-N-(2-hydroxyethyl) perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of commercially available such anionic surfactants having a fluoroalkyl group include, but are not limited to, SURFLON® S-111, S-112, and S-113 (from AGC Seimi Chemical Co., Ltd.); FLUORAD™ FC-93, FC-95, FC-98, and FC-129 (from Sumitomo 3M); UNIDYNE™ DS-101 and DS-102 (from Daikin Industries, Ltd.); MEGAFACE F-110, F-120, F-113, F-191, F-812, and F-833 (from DIC Corporation); EFTOP EF-102, 103, 104, 105, 112, 123A, 123B, 306A, 501, 201, and 204 (from Mitsubishi Materials Electronic Chemicals Co., Ltd.); and FTERGENT F-100 and F-150 (from Neos Company Limited).

Specific examples of cationic surfactants having a fluoroalkyl group include, but are not limited to, aliphatic primary, secondary, and tertiary amine acids having a fluoroalkyl group; and aliphatic quaternary ammonium salts such as perfluoroalkyl(C6-C10) sulfonamide propyl trimethyl ammonium salts, benzalkonium salts, benzethonium chlorides, pyridinium salts, and imidazolinium salts.

Specific examples of commercially available such cationic surfactants having a fluoroalkyl group include, but are not limited to, SURFLON® S-121 (from AGC Seimi Chemical Co., Ltd.); FLUORAD™ FC-135 (from Sumitomo 3M); UNIDYNE™ DS-202 (from Daikin Industries, Ltd.); MEGAFACE F-150 and F-824 (from DIC Corporation); EFTOP EF-132 (from Mitsubishi Materials Electronic Chemicals Co., Ltd.); and FTERGENT F-300 (from Neos Company Limited).

Inorganic compounds, such as tricalcium phosphate, calcium carbonate, titanium oxide, colloidal silica, and hydroxyapatite, are also usable as the dispersant.

Additionally, polymeric protection colloids are also usable so as to more stabilize the dispersing oil droplets.

Specific examples of usable polymeric protection colloids include, but are not limited to, homopolymers and copolymers obtained from monomers, such as acid monomers (e.g., acrylic acid, methacrylic acid, α-cyanoacrylic acid, α-cyanomethacrylic acid, itaconic acid, crotonic acid, fumaric acid, maleic acid, maleic anhydride), acrylate and methacrylate monomers having hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, N-methylol methacrylamide), vinyl ether monomers (e.g., vinyl methyl ether, vinyl ethyl ether, vinyl propyl ether), vinyl carboxylate monomers (e.g., vinyl acetate, vinyl propionate, vinyl butyrate), amide monomers (e.g., acrylamide, methacrylamide, diacetone acrylamide) and methylol compounds thereof, acid chloride monomers (e.g., acrylic acid chloride, methacrylic acid chloride), and/or monomers containing nitrogen or a nitrogen-containing heterocyclic ring (e.g., vinyl pyridine, vinyl pyrrolidone, vinyl imidazole, ethylene imine); polyoxyethylene-based resins (e.g., polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester, polyoxyethylene nonyl phenyl ester); and celluloses (e.g., methyl cellulose, hydroxyethyl cellulose, hydroxypropyl cellulose).

In a case in which an acid-soluble or alkali-soluble compound (e.g., calcium phosphate) is used as the dispersant, preferably, the resulting toner particles are first washed with an acid (e.g., hydrochloric acid) or an alkali and then washed with water. Alternatively, such a dispersant can be removed with an enzyme.

The dispersant may remain on the surface of the resulting toner. However, it is preferable that the dispersant is washed or removed after the termination of the elongation and/or cross-linking reaction, in terms of chargeability of the toner.

To further reduce the viscosity of the toner components liquid to obtain toner particles with a narrower size distribution, solvents which can dissolve the modified polyester resin produced from the polyester prepolymer are preferable.

More preferably, the solvents are volatile and have a boiling point less than 100° C., because such solvents are easily removable.

Specific examples of such solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Two or more of these solvents can be used in combination.

Among these solvents, aromatic solvents (e.g., toluene, xylene) and halogenated hydrocarbons (e.g., methylene chloride, 1,2-dichloroethane, chloroform, carbon tetrachloride) are preferable.

The used amount of the solvent is preferably from 0 to 300 parts by weight, more preferably from 0 to 100 parts by weight, and most preferably from 25 to 70 parts by weight, based on 100 parts by weight of the polyester prepolymer. The solvent is removed by application of heat at normal or reduced pressures after the termination of the elongation and/or cross-linking reaction.

The elongation and/or cross-linking reaction time between the polyester prepolymer and the compound having an active hydrogen group is preferably from 10 minutes to 40 hours, and more preferably from 30 minutes to 24 hours. The reaction temperature is preferably from 0 to 100° C., and more preferably from 10 to 50° C. A catalyst (e.g., tertiary amines such as triethylamine, imidazole) can be used, if needed.

The solvent can be removed from the emulsion by gradually heating the emulsion to completely evaporate the solvent from liquid droplets. Alternatively, the solvent can be removed from the emulsion by spraying the emulsion into dry atmosphere to completely evaporate the solvent from liquid droplets. In the latter case, aqueous dispersants, if any, can also be evaporated.

The dry atmosphere into which the emulsion is sprayed may be, for example, air, nitrogen gas, carbon dioxide gas, or combustion gas, which is heated to above the maximum boiling point among the solvents. Such a treatment can be reliably performed by a spray drier, a belt drier, or a rotary kiln, within a short period of time.

In a case in which the emulsion is subjected to washing and drying treatments while containing toner particles having a wide size distribution, the toner particles are preferably subjected to a classification treatment.

Specifically, the classification treatment removes undesired-size particles from the resulting particles in a liquid by a cyclone, a decanter, or a centrifugal separator. Of course, the classification treatment can be performed after drying the resulting particles, but is more effectively performed in a liquid. The collected undesired-size particles, either in dry or wet condition, can be reused for preparation of toner particles.

The dispersant is preferably removed in the process of the classification treatment.

The dried toner particles are optionally mixed with fine particles of a release agent, a charge controlling agent, a fluidizer, and/or a colorant, and these fine particles can be fixedly adhered to the surfaces of the toner particles by application of mechanical impulsive force.

Mechanical impulsive force can be applied by agitating toner particles using blades rotating at a high speed, or accelerating toner particles by a high-speed airflow to collide with a collision plate.

Such a treatment can be performed by ONG MILL (from Hosokawa Micron Co., Ltd.), a modified I TYPE MILL in which the pulverizing air pressure is reduced (from Nippon Pneumatic Mfg. Co., Ltd.), HYBRIDIZATION SYSTEM (from Nara Machine Co., Ltd.), KRYPTON SYSTEM (from Kawasaki Heavy Industries, Ltd.), or an automatic mortar.

In this specification, the hydroxyl values can be measured based on a method according to JIS K0070-1966 as follows.

First, 0.5 g of a sample is precisely weighed in a 100-ml measuring flask, and 5 ml of an acetylating reagent are further added to the flask.

The flask is heated in a warm bath at 100±5° C. for 1 to 2 hours, followed by cooling outside of the warm bath. Water is added to the flask and the flask is shaken so that the produced acetic anhydride is decomposed.

Subsequently, to completely decompose the acetic anhydride, the flask is reheated in the warm bath for at least 10 minutes, followed by cooling, and the inner wall surface of the flask is washed with an organic solvent.

The content in the flask is subjected to measurement of hydroxyl value using an automatic potentiometric titrator DL-53 TITRATOR and an electrode DG113-SC (both from Mettler-Toledo International Inc.) at 23° C. The measurement results are analyzed with an analysis software program LabX Light Version 1.00.000. The titrator is calibrated with a mixed solvent of 120 ml of toluene and 30 ml of ethanol.

The detailed measurement settings are as follows.

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| Volume [mL] | 1.0 |
|---|---|
| Wait time [s] | 0 |
| Titrant addition | Dynamic |
| dE(set) [mV] | 8.0 |
| dV(min) [mL] | 0.03 |
| dV(max) [mL] | 0.5 |
| Measure mode | Equilibrium controlled |
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination condition | No |

Evaluation

| Procedure | Standard |
|---|---|
| Potential 1 | No |
| Potential 2 | No |
| Stop for reevaluation | No |

In this specification, the acid values are measured based on a method according to JIS K0070-1992 as follows.

First, 0.5 g of a sample are added to 120 ml of toluene, and the resulting mixture is agitated for about 10 hours at 23° C. so that the sample is dissolved in the toluene, followed by addition of 30 ml of ethanol. Thus, a solution of the sample is prepared. In case the sample is not dissolved, dioxane or tetrahydrofuran can be added.

The solution of the sample is titrated with a 0.1 N alcohol solution of potassium hydroxide using an automatic potentiometric titrator DL-53 TITRATOR and an electrode DG113-SC (both from Mettler-Toledo International Inc.) at 23° C. The measurement results are analyzed with an analysis software program LabX Light Version 1.00.000. The titrator is calibrated with a mixed solvent of 120 ml of toluene and 30 ml of ethanol.

The detailed measurement settings are the same as those for measuring the hydroxyl value.

The acid value is calculated from the following equation:

AV(mgKOH/g)=X×N×56.1/W

wherein X represents a titer (ml), N represents the factor of the 0.1 N alcohol solution of potassium hydroxide, and W represents the weight of the sample.

The acid value of the toner is attributable to the existence of terminal carboxyl groups in the unmodified polyester resin, and represents low-temperature fixability and hot offset resistance. Preferably, the toner has an acid value of from 0.5 to 40 KOHmg/g to have proper low-temperature fixability and hot offset resistance.

When the acid value is too large, it means that the elongating and/or cross-linking reaction of the prepolymer is undergone insufficiently, resulting in poor hot offset resistance. When the acid value is too small, it means that the elongating and/or cross-linking reaction of the prepolymer is undergone excessively, resulting in poor manufacture stability.

The endothermic peak temperatures and endothermic shoulder temperatures of the above-described resins and toners can be measured using a differential scanning calorimeter system DSC-60 (Shimadzu Corporation).

FIGURE shows an exemplary differential scanning calorimetric (hereinafter “DSC”) chart of the crystalline polyester resin.

The first endothermic shoulder temperatures (T1-cs1) and (T2-cs1) and the second endothermic shoulder temperatures (T1-cs2) and (T2-cs2) illustrated in FIGURE are determined by the following procedures.

First, about 5.0 mg of a sample is contained in an aluminum container, and the container is put on a holder unit to be set in an electric furnace.

The sample is heated from 0° C. to 150° C. at a heating rate of 10° C./min under nitrogen atmosphere, and subsequently cooled from 150° C. to 0° C. at a cooling rate of 10° C./min, followed by reheating from 0° C. to 150° C. at a heating rate of 10° C./min, while the differential scanning calorimeter system DSC-60 measuring DSC curves.

An analysis software program in the DSC-60 analyzes the first and second endothermic shoulder temperatures (T1-cs1) and (T1-cs2) in the DSC curve obtained in the first heating, and the first and second endothermic shoulder temperatures (T2-cs1) and (T2-cs2) in the DSC curve obtained in the second heating. Generally, the first endothermic temperature is lower than the second endothermic temperature.

Similarly, the analysis software program in the DSC-60 analyzes the endothermic peak temperatures (T1-cp) and (T2-cp) in the DSC curves respectively obtained in the first and second heating.

With respect to the toner, the endothermic shoulder temperature (T1-ts1) determined from the first heating is preferably from 45 to 65° C., more preferably from 50 to 60° C. so as to have low-temperature fixability, heat-resistant storage stability, and high durability. When (T1-ts1) is too small, the toner may cause blocking in a developing device or filming on a photoreceptor. When (T1-ts1) is too large, low-temperature fixability of the toner may be poor.

Additionally, the endothermic shoulder temperature (T2-ts1) determined from the second heating is preferably from 20 to 40° C. When (T2-ts1) is too small, the toner may cause blocking in a developing device or filming on a photoreceptor. When (T2-ts1) is too large, low-temperature fixability of the toner may be poor.

Particle diameter distributions of the toner can be measured with an instrument COULTER COUNTER TA-II or COULTER MULTISIZER II (both from Beckman Coulter, Inc.).

In this specification, particle diameter distributions are measured with an instrument COULTER COUNTER TA-II connected to an interface (from The Institute of Japanese Union of Scientists & Engineers) and a personal computer PC9801 (from NEC Corporation) for calculating number and volume particle size distribution, as follows.

First, 0.1 to 5 ml of a surfactant (preferably an alkylbenzene sulfonate) are included in 100 to 150 ml of an electrolyte. The electrolyte is a 1% aqueous solution of the first grade sodium chloride, for example, ISOTON-II (from Coulter Electrons Inc.). Thereafter, 2 to 20 mg of a sample are added to the electrolyte and dispersed using an ultrasonic dispersing machine for about 1 to 3 minutes to prepare a toner suspension liquid. The weight and number of toner particles in the toner suspension liquid are measured by the above instrument equipped with an aperture of 100 μm.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Accordingly, particles having a particle diameter of from not less than 2.00 μm to less than 40.30 μm were measured.

The toner according to this specification preferably has a volume average particle diameter of from 3 to 7 μm, and the ratio of the volume average particle diameter to the number average particle diameter is preferably 1.2 or less.

Additionally, the toner preferably includes toner particles having a particle diameter of 2 μm or less in an amount of from 1 to 10% by number.

The toner according to this specification may be used for both a one-component developer and a two-component developer.

The two-component developer is prepared by mixing the toner with a magnetic carrier. The weight ratio of the toner to the carrier is preferably 1/100 to 10/100.

The magnetic carrier may be a ferrite powder, a magnetite powder, or a magnetic resin carrier, each having a particle diameter of about 20 to 200 μm.

The surface of the magnetic carrier may be covered with resins such as amino resins (e.g., urea-formaldehyde resin, melamine resin, benzoguanamine resin, urea resin, polyamide resin, epoxy resin), polyvinyl or polyvinylidene resins (e.g., acrylic resin, polymethyl methacrylate resin, polyacrylonitrile resin, polyvinyl acetate resin, polyvinyl alcohol resin, polyvinyl butyral resin), polystyrene-based resins (e.g., polystyrene resin, styrene-acrylic copolymer resin), halogenated olefin resins (e.g., polyvinyl chloride), polyester resins (e.g., polyethylene terephthalate resin, polybutylene terephthalate resin), polycarbonate resins, polyethylene resins, polyvinyl fluoride resins, polyvinylidene fluoride resins, poly(trifluoroethylene) resins, poly(hexafluoropropylene) resins, vinylidene fluoride-acrylic monomer copolymer, vinylidene fluoride-vinyl fluoride copolymer, fluoroterpolymers (e.g., tetrafluoroethylene-vinylidene fluoride-non-fluoride monomer terpolymer), silicone resins, and epoxy resins.

The above resins may include conductive powders. Specific examples of usable conductive powders include, but are not limited to, metal powders, carbon black, titanium oxide, tin oxide, and zinc oxide. The conductive powders preferably have an average diameter of 1 μm or less. When the average diameter is too large, it is difficult to control electric resistivity.

The toner according to this specification is usable as a one-component developer without using a carrier.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Manufacture Example 1

### Preparation of Crystalline Polyester Resin 1

A 5-liter 4-necked flask equipped with a nitrogen inlet pipe, a dewatering tube, a stirrer, and a thermocouple was charged with 2,300 g of 1,10-decanediol, 2,530 g of 1,8-octanediol, and 4.9 g of hydroquinone. The mixture was subjected to reaction for 10 hours at 180° C., subsequently for 3 hours at 200° C., and subsequently 2 hours at 8.3 KPa. Thus, a crystalline polyester resin 1 was prepared.

### Manufacture Example 2

### Preparation of Crystalline Polyester Resin 2

A 5-liter 4-necked flask equipped with a nitrogen inlet pipe, a dewatering tube, a stirrer, and a thermocouple was charged with 2,300 g of 1,10-decanedioic acid, 2,530 g of 1,8-octanediol, and 4.9 g of hydroquinone. The mixture was subjected to reaction for 5 hours at 170° C., subsequently for 2 hours at 190° C., and subsequently 1 hour at 7.8 KPa. Thus, a crystalline polyester resin 2 was prepared.

### Manufacture Example 3

### Preparation of Crystalline Polyester Resin 3

A 5-liter 4-necked flask equipped with a nitrogen inlet pipe, a dewatering tube, a stirrer, and a thermocouple was charged with 2,300 g of 1,10-decanedioic acid, 2,530 g of 1,8-octanediol, and 4.9 g of hydroquinone. The mixture was subjected to reaction for 10 hours at 180° C., subsequently for 3 hours at 200° C., and subsequently 2 hours at 8.3 KPa. Thus, a crystalline polyester resin 3 was prepared.

### Manufacture Example 4

### Preparation of Crystalline Polyester Resin 4

A 5-liter 4-necked flask equipped with a nitrogen inlet pipe, a dewatering tube, a stirrer, and a thermocouple was charged with 2,300 g of 1,10-decanedioic acid, 2,530 g of 1,10-dodecanediol, and 4.9 g of hydroquinone. The mixture was subjected to reaction for 10 hours at 180° C., subsequently for 3 hours at 200° C., and subsequently 2 hours at 8.3 KPa. Thus, a crystalline polyester resin 4 was prepared.

### Manufacture Example 5

### Preparation of Crystalline Polyester Resin 5

A 5-liter 4-necked flask equipped with a nitrogen inlet pipe, a dewatering tube, a stirrer, and a thermocouple was charged with 2,160 g of fumaric acid, 2,320 g of 1,6-hexanediol, and 4.9 g of hydroquinone. The mixture was subjected to reaction for 10 hours at 180° C., subsequently for 3 hours at 200° C., and subsequently 2 hours at 8.3 KPa. Thus, a crystalline polyester resin 5 was prepared.

### Manufacture Example 6

### Preparation of Crystalline Polyester Resin 6

A 5-liter 4-necked flask equipped with a nitrogen inlet pipe, a dewatering tube, a stirrer, and a thermocouple was charged with 2,320 g of 1,10-adipic acid, 2,880 g of 1,8-pentanediol, and 4.9 g of hydroquinone. The mixture was subjected to reaction for 10 hours at 180° C., subsequently for 3 hours at 200° C., and subsequently 2 hours at 8.3 KPa. Thus, a crystalline polyester resin 6 was prepared.

Properties of the crystalline polyester resins 1 to 6 are shown in Table 1.

TABLE I

| Crystalline | | | | | | |
|---|---|---|---|---|---|---|
| Polyester | T2-cp | T2-cs1 | T2-cs2 | | | |
| Resin No. | (° C.) | (° C.) | (° C.) | Mw | Mn | Mw/Mn |
| 1 | 70 | 65 | 73 | 10,000 | 3,000 | 3.3 |
| 2 | 63 | 58 | 68 | 8,500 | 2,500 | 3.4 |
| 3 | 78 | 72 | 82 | 12,000 | 3,500 | 3.4 |
| 4 | 70 | 62 | 78 | 12,000 | 2,000 | 6.0 |
| 5 | 85 | 65 | 98 | 13,000 | 2,500 | 5.2 |
| 6 | 58 | 40 | 63 | 12,000 | 2,300 | 5.2 |

### Manufacture Example 7

### Preparation of Amorphous Polyester Resin 1

A 5-liter 4-necked flask equipped with a nitrogen inlet pipe, a dewatering tube, a stirrer, and a thermocouple was charged with 229 pars of ethylene oxide 2 mol adduct of bisphenol A, 529 parts of propylene oxide 3 mol adduct of bisphenol A, 100 parts of isophthalic acid, 108 parts of terephthalic acid, 46 parts of adipic acid, and 2 parts of dibutyltin oxide. The mixture was subjected to reaction for 10 hours at 230° C. under normal pressure, and subsequently for 5 hours under reduced pressures of 10 to 15 mmHg. After adding 30 parts of trimellitic anhydride, the mixture was further subjected to reaction for 3 hours at 180° C. under normal pressure. Thus, an amorphous polyester resin 1 was prepared.

The amorphous polyester resin 1 had a number average molecular weight of 1,800, a weight average molecular weight of 5,500, a glass transition temperature (Tg) of 50° C., and an acid value of 20 mgKOH/g.

### Manufacture Example 8

### Preparation of Amorphous Polyester Resins 2 to 4

The procedure in Manufacture Example 7 for preparing the amorphous polyester resin 1 was repeated except for changing the type and amount of alcohol and acid components, reaction temperature, reaction time, and/or reaction pressure. Thus, amorphous polyester resins 2 to 4 were prepared.

Properties of the amorphous polyester resins 1 to 4 are shown in Table 2.

TABLE 2

| Amorphous | | | | |
|---|---|---|---|---|
| Polyester | T2-ns | | | |
| Resin No. | (° C.) | Mw | Mn | Mw/Mn |
| 1 | 50 | 5,500 | 1,800 | 3.1 |
| 2 | 43 | 4,500 | 1,500 | 3.0 |
| 3 | 66 | 8,500 | 2,700 | 3.1 |
| 4 | 56 | 6,200 | 2,100 | 3.0 |

### Manufacture Example 9

### Preparation of Polyester Prepolymer

A reaction vessel equipped with a condenser, a stirrer, and a nitrogen inlet pipe was charged with 682 pars of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. The mixture was subjected to reaction for 8 hours at 230° C. under normal pressure, and subsequently for 5 hours under reduced pressures of 10 to 15 mmHg. Thus, an intermediate polyester 1 was prepared.

The intermediate polyester 1 had a number average molecular weight of 2,100, a weight average molecular weight of 9,500, a glass transition temperature (Tg) of 55° C., an acid value of 0.5 mgKOH/g, and a hydroxyl value of 51 mgKOH/g.

Another reaction vessel equipped with a condenser, a stirrer, and a nitrogen inlet pipe was charged with 410 parts of the intermediate polyester 1, 89 parts of isophorone diisocyanate, and 500 parts of ethyl acetate. The mixture was subjected to reaction for 5 hours at 100° C. Thus, a prepolymer 1 was prepared.

The prepolymer 1 included free isocyanates in an amount of 1.53%.

### Manufacture Example 10

### Preparation of Ketimine

A reaction vessel equipped with a stirrer and a thermometer was charged with 170 parts of isophoronediamine and 75 parts of methyl ethyl ketone. The mixture was subjected to reaction for 5 hours at 50° C. Thus, a ketimine compound 1 was prepared.

The ketimine compound 1 had an amine value of 418 mgKOH/g.

### Manufacture Example 11

### Preparation of Master Batch

First, 1,200 parts of water, 540 parts of a carbon black having a DBP oil absorption of 42 ml/100 g and a pH of 9.5 (PRINTEX 35 from Degussa), and 1,200 parts of a polyester resin were mixed using a HENSCHEL MIXER (from Mitsui Mining and Smelting Co., Ltd.). The resulting mixture was kneaded for 30 minutes at 150° C. using a double roll, the kneaded mixture was then rolled and cooled, and the rolled mixture was then pulverized into particles using a pulverizer. Thus, a master batch 1 was prepared.

### Manufacture Example 12

### Preparation of Oil Phase

A vessel equipped with a stirrer and a thermometer was charged with 378 parts of the amorphous polyester resin 1, 110 parts of a carnauba wax, 22 parts of a charge controlling agent (a metal complex of salicylic acid BONTRON® E-84 from Orient Chemical Industries Co., Ltd.), and 947 parts of ethyl acetate. The mixture was heated to 80° C. while being agitated, kept at 80° C. for 5 hours, and then cooled to 30° C. over a period of 1 hour. Further, 500 parts of the master batch 1 and 500 parts of ethyl acetate were added to the vessel, and the mixture was agitated for 1 hour. Thus, a raw material liquid 1 was prepared.

Next, 1,324 parts of the raw material liquid was then subjected to a dispersion treatment using a bead mill (ULTRAVISCOMILL (trademark) from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Further, 1,042.3 parts of a 65% ethyl acetate solution of the amorphous polyester resin 1 were added, and the mixture was subjected to the above dispersion treatment again except for changing the repeat number of dispersion operation to 1 time. Thus, a colorant-wax dispersion 1 was prepared. The colorant-wax dispersion 1 contained solid components in an amount of 50% by weight.

### Manufacture Example 13

### Preparation of Crystalline Polyester Resin Dispersions

A 2-liter metallic container was charged with 100 g of the crystalline polyester resin 1 and 400 g of ethyl acetate. The container was heated to 75° C. so that the crystalline polyester resin 1 dissolved in the ethyl acetate, followed by rapid cooling in an ice water bath at a cooling rate of 27° C./min. After adding 500 ml of glass beads having a diameter of 3 mm to the container, the mixture was subjected to pulverization for 10 hours using a batch-type sand mill (from Kanpe Hapio Co., Ltd.). Thus, a crystalline polyester resin dispersion 1 was prepared.

Crystalline polyester resin dispersions 2 to 6 were prepared in the same manner except for replacing the crystalline polyester resin 1 with the crystalline polyester resins 2 to 6, respectively.

### Manufacture Example 14

### Preparation of Particulate Resin Emulsion

A reaction vessel equipped with a stirrer and a thermometer was charged with 683 parts of water, 11 parts of a sodium salt of a sulfate of ethylene oxide adduct of methacrylic acid (ELEMINOL RS-30 from Sanyo Chemical Industries, Ltd.), 138 parts of styrene, 138 parts of methacrylic acid, and 1 part of ammonium persulfate. The mixture was agitated for 15 minutes at a revolution of 400 rpm, thus preparing a whitish emulsion. The emulsion was then heated to 75° C. and subjected to reaction for 5 hours. Thereafter, 30 parts of a 1% aqueous solution of ammonium persulfate were added thereto, and the resulting mixture was aged for 5 hours at 75° C. Thus, an aqueous dispersion of a vinyl resin (i.e., a copolymer of styrene, methacrylic acid, and a sodium salt of a sulfate of ethylene oxide adduct of methacrylic acid) was prepared. This dispersion was hereinafter called as the particulate resin dispersion 1.

Resin particles in the particulate resin dispersion 1 had a volume average particle diameter of 0.14 μm when measured by a laser diffraction particle size distribution analyzer LA-920 (from Horiba, Ltd.).

### Manufacture Example 15

### Preparation of Aqueous Medium

An aqueous medium was prepared by mixing and agitating 990 parts of water, 83 parts of the particulate resin dispersion 1, 37 parts of a 48.5% aqueous solution of dodecyl diphenyl ether sodium disulfonate (MON-7 from Sanyo Chemical Industries, Ltd.), and 90 parts of ethyl acetate. Thus, an aqueous medium 1, which was whitish, was prepared.

### Example 1

### Manufacture Example 16

### Emulsification and Solvent Removal

First, 664 parts of the colorant-wax dispersion 1, 109.4 parts of the prepolymer 1, 73.9 parts of the crystalline polyester resin dispersion 1, and 4.6 parts of the ketimine compound 1 were contained in a vessel, and the mixture was agitated for 1 minute at a revolution of 5,000 rpm using a TK HOMOMIXER (from PRIMIX Corporation). Further, 1,200 parts of the aqueous medium 1 were added to the vessel, and the mixture was agitated for 20 minutes at a revolution of 13,000 rpm using the TK HOMOMIXER. Thus, an emulsion slurry 1 was prepared.

The emulsion slurry 1 was contained in a vessel equipped with a stirrer and a thermometer, and subjected to solvent removal for 8 hours at 30° C., and subsequent aging for 4 hours at 45° C. Thus, a dispersion slurry 1 was prepared.

### (Washing and Drying)

First, 100 parts of the dispersion slurry 1 was filtered under reduced pressures, thus obtaining a wet cake (i).

The wet cake (i) was mixed with 100 parts of ion-exchange water using a TK HOMOMIXER for 10 minutes at a revolution of 12,000 rpm, followed by filtering, thus obtaining a wet cake (ii).

The wet cake (ii) was mixed with 100 parts of a 10% aqueous solution of sodium hydroxide using a TK HOMOMIXER for 30 minutes at a revolution of 12,000 rpm, followed by filtering under reduced pressures, thus obtaining a wet cake (iii).

The wet cake (iii) was mixed with 100 parts of a 10% hydrochloric acid using a TK HOMOMIXER for 10 minutes at a revolution of 12,000 rpm, followed by filtering, thus obtaining a wet cake (iv).

The wet cake (iv) was mixed with 300 parts of ion-exchange water using a TK HOMOMIXER for 10 minutes at a revolution of 12,000 rpm, followed by filtering. This operation was repeated twice, thus obtaining a wet cake (v).

The wet cake (v) was dried by a drier for 48 hours at 45° C., and filtered with a mesh having openings of 75 μm. Thus, a toner 1 was prepared.

### Example 2

The procedure in Example 1 was repeated except for replacing the crystalline polyester resin dispersion 1 with the crystalline polyester resin dispersion 2.

### Example 3

The procedure in Example 1 was repeated except for replacing the crystalline polyester resin dispersion 1 with the crystalline polyester resin dispersion 3.

### Example 4

The procedure in Example 1 was repeated except for replacing the crystalline polyester resin dispersion 1 with the crystalline polyester resin dispersion 4.

### Example 5

The procedure in Example 1 was repeated except for replacing the amorphous polyester resin 1 with the amorphous polyester resin 2.

### Example 6

The procedure in Example 1 was repeated except for replacing the amorphous polyester resin 1 with the amorphous polyester resin 3.

### Example 7

The procedure in Example 1 was repeated except for replacing the amorphous polyester resin 1 with the amorphous polyester resin 4.

### Comparative Example 1

The procedure in Example 1 was repeated except that no crystalline polyester resin was added.

### Comparative Example 2

The procedure in Example 1 was repeated except for replacing the crystalline polyester resin dispersion 1 with the crystalline polyester resin dispersion 5.

### Comparative Example 3

The procedure in Example 1 was repeated except for replacing the crystalline polyester resin dispersion 1 with the crystalline polyester resin dispersion 6.

The resin compositions of the toners prepared in Examples and Comparative Examples are shown in Table 3.

TABLE 3

| | Crystalline | Amorphous |
|---|---|---|
| | Polyester Resin | Polyester Resin |
| | No. | No. |
| Example 1 | 1 | 1 |
| Example 2 | 2 | 1 |
| Example 3 | 3 | 1 |
| Example 4 | 4 | 1 |
| Example 5 | 1 | 2 |
| Example 6 | 1 | 3 |
| Example 7 | 1 | 4 |
| Comparative Example 1 | — | 1 |
| Comparative Example 2 | 5 | 1 |
| Comparative Example 3 | 6 | 1 |

### Preparation of Developers

Each of the above-prepared toners in an amount of 100 parts was mixed with 0.7 parts of a hydrophobized silica and 0.3 parts of a hydrophobized titanium oxide using a HENSCHEL MIXER.

Further, 5% of each of the above-treated toners and 95% of a silicone-resin-covered copper-zinc ferrite carrier having an average particle diameter of 40 μm were mixed to prepare a developer.

### Evaluation of Fixability

Each of the above-prepared developers was set in a copier MF2200 (from Ricoh Co., Ltd.) employing a TEFLON® fixing roller, in which the fixing part is modified.

Images were produced on a paper TYPE 6200 (from Ricoh Co., Ltd.) while varying the fixing temperature so as to determine a minimum fixable temperature below which cold offset occurs and a maximum fixable temperature above which hot offset occurs.

When determining the minimum fixable temperature, the linear speed of paper feeding was set to between 120 and 150 mm/sec, the surface pressure was set to 1.2 kgf/cm², and the nip width was set to 3 mm.

When determining the maximum fixable temperature, the linear speed of paper feeding was set to 50 mm/sec, the surface pressure was set to 2.0 kgf/cm², and the nip width was set to 4.5 mm.

### Evaluation of Heat-Resistant Storage Stability

Each of the above-prepared toners was stored at 50° C. for 8 hours. Thereafter, each of the toners was sieved with a 42-mesh sieve for 2 minutes, and the residual rate of the toner remaining on the sieve was measured to evaluate heat-resistant storage stability. The smaller the residual rate, the better the heat-resistant storage stability.

The heat-resistant storage stability was graded into 4 levels according to the residual rate.

A: The residual rate was less than 10%.

B: The residual rate was not less than 10% and less than 20%.

C: The residual rate was not less than 20% and less than 30%.

D: The residual rate was not less than 30%.

The evaluation results are shown in Table 4.

TABLE 4

| | | | Minimum | Maximum | Heat- |
|---|---|---|---|---|---|
| | | | Fixable | Fixable | Resistant |
| | T1-ts | T2-ts | Temperature | Temperature | Storage |
| | (° C.) | (° C.) | (° C.) | (° C.) | Stability |
| Example 1 | 58 | 30 | 120 | 190 | A |
| Example 2 | 55 | 28 | 120 | 180 | B |
| Example 3 | 60 | 35 | 125 | 190 | A |
| Example 4 | 56 | 32 | 125 | 180 | B |
| Example 5 | 50 | 28 | 120 | 175 | B |
| Example 6 | 62 | 38 | 130 | 190 | A |
| Example 7 | 60 | 32 | 125 | 190 | A |
| Comparative | 58 | 50 | 140 | 190 | A |
| Example 1 | | | | | |
| Comparative | 58 | 45 | 135 | 190 | B |
| Example 2 | | | | | |
| Comparative | 44 | 28 | 125 | 170 | D |
| Example 3 | | | | | |

As is clear from Table 4, the toners of Examples 1 to 7 have a good combination of low-temperature fixability and heat-resistant storage stability.

In Comparative Example 1, low-temperature fixability is poor because the toner includes no crystalline polyester resin.

In Comparative Example 2, low-temperature fixability is poor because the toner includes the crystalline polyester resin 5 which has a high endothermic peak temperature (T2-cp) and a large difference between the endothermic peak temperature (T2-cp) and the endothermic shoulder temperatures (T2-cs1) and (T2-cs2).

In Comparative Example 3, heat-resistant storage stability is poor because the toner includes the crystalline polyester resin 6 which has a low endothermic peak temperature (T2-cp) and a large difference between the endothermic peak temperature (T2-cp) and the endothermic shoulder temperatures (T2-cs1) and (T2-cs2).

Additional modifications and variations of the present invention are possible in light of the above teachings. It is therefore to be understood that within the scope of the appended claims the invention may be practiced other than as specifically described herein.

What is claimed is:

1. A toner, comprising:
a colorant;
a crystalline polyester resin; and
an amorphous polyester resin,
wherein the crystalline polyester resin satisfies the following relations:
60≦(T2-cp)<80
(T2-cs2)−(T2-cp)<10
(T2-cp)−(T2-cs1)<10
wherein (T2-cp) (° C.) represents an endothermic peak temperature, (T2-cs1) (° C.) represents a first endothermic shoulder temperature, and (T2-cs2) (° C.) represents a second endothermic shoulder temperature, each determined from a second heating in a differential scanning calorimetry.

2. The toner according to claim 1, wherein the crystalline polyester resin further satisfies the following relation:
65≦(T2-cp)<75

3. The toner according to claim 1, wherein the crystalline polyester resin further satisfies the following relations:
(T2-cs2)−(T2-cp)<6
(T2-cp)−(T2-cs1)<6

4. The toner according to claim 1, wherein the toner satisfies the following relation:
45≦(T1-ts1)<65
wherein (T1-ts1) (° C.) represents an endothermic shoulder temperature determined from a first heating in the differential scanning calorimetry.

5. The toner according to claim 1, wherein the toner satisfies the following relation:
20≦(T2-ts1)<40
wherein (T2-ts1) (° C.) represents an endothermic shoulder temperature determined from the second heating in the differential scanning calorimetry.

6. The toner according to claim 1, wherein o-dichlorobenzene-soluble components in the crystalline polyester resin has a weight average molecular weight (Mw) of from 3,000 to 30,000 and a number average molecular weight (Mn) of from 1,000 to 10,000, and a ratio Mw/Mn is from 1 to 10, when measured by gel permeation chromatography.

7. The toner according to claim 6, wherein o-dichlorobenzene-soluble components in the crystalline polyester resin has a weight average molecular weight (Mw) of from 5,000 to 15,000 and a number average molecular weight (Mn) of from 2,000 to 10,000, and a ratio Mw/Mn is from 1 to 5, when measured by gel permeation chromatography.

8. The toner according to claim 1, wherein a weight ratio of the crystalline polyester resin to the amorphous polyester resin is from 3/97 to 45/55.

9. The toner according to claim 1, wherein the toner is manufactured by a method, comprising:
dispersing an oil phase in an aqueous medium to prepare an O/W dispersion, the oil phase comprising an organic solvent, the colorant, the crystalline polyester resin, and the amorphous polyester resin; and
removing the organic solvent from the O/W dispersion.

10. The toner according to claim 1, wherein the amorphous polyester resin comprises an unmodified polyester resin and a modified polyester resin.

11. The toner according to claim 10, wherein the unmodified polyester resin satisfies the following relation:
45≦(T2-ns1)<65
wherein (T2-ns1) (° C.) represents an endothermic shoulder temperature determined from the second heating in the differential scanning calorimetry.

12. The toner according to claim 11, wherein the unmodified polyester resin satisfies the following relation:
45≦(T2-ns1)<55
wherein (T2-ns1) (° C.) represents an endothermic shoulder temperature determined from the second heating in the differential scanning calorimetry.

13. The toner according to claim 10, wherein the toner is manufactured by a method, comprising:
dispersing an oil phase in an aqueous medium containing a particle dispersant to prepare an O/W dispersion, the oil phase comprising an organic solvent, the colorant, the crystalline polyester resin, the unmodified polyester resin, a precursor of the modified polyester resin, and a compound capable of elongating and/or cross-linking with the precursor;
elongating and/or cross-linking the compound with the precursor in the O/W dispersion; and
removing the organic solvent from the O/W dispersion.

14. A developer, comprising the toner according to claim 1.
